(19) United States
(12) Patent Application Publication
(10) Pub. No.: US 2006/0029448 A1
(43) Pub. Date: Feb. 9, 2006

(54) Control method of image processing apparatus, image processing apparatus, and control program of image processing apparatus

(75) Inventor: Seiya Fujinaga, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/190,007

(22) Filed: Jul. 27, 2005

(30) Foreign Application Priority Data
Aug. 5, 2004 (JP) 2004-228773

(51) Int. Cl. B41J 29/38

(52) U.S. Cl. 400/76

(57) ABSTRACT

In a state in which a special print mode (seal mode) is selected, when a user performs an operation for changeover to the sheet feeding unit set with the attribute inconsistent with the print mode, the attribute setup user interface of the sheet feeding unit selected by the changeover operation is activated, and after the attribute of the sheet feeding unit is set up, the changeover to the sheet feeding unit selected by the changeover operation is executed. Even in case a print mode inconsistent with the attribute setup state of a sheet feeding unit is used, a sheet feed changeover is allowed to be performed by an easy operation.

### BACKGROUND OF THE INVENTION

1. Field of the Invention

The present invention relates to a control method of an image processing apparatus comprising a plurality of sheet feeding units capable of setting up each attribute regarding each sheet to be stored and a recording unit for performing a print output by using the sheet of the sheet feeding unit selected by a user from the sheet feeding units, an image processing apparatus, and a control program of an image processing apparatus.

2. Related Background Art

Heretofore, in the image processing apparatus for performing image recording such as a copier and the like, a technique for controlling an image output by a print job (hereinafter referred to simply as job) unit has been known. According to the control by this job unit, print conditions (attribute values) such as the type and size of the sheet are designated for every job.

In the meantime, according to the image processing apparatus of this type, the apparatus having a plurality of sheet feeding units (for example, a plurality of sheet cassettes and sheet feeding ports for manual feed sheets) has been known, and there are often the cases where these sheet feeding units are loaded in advance with specific sheets or in a state or specification in which only specific sheets can be used.

Consequently, there has been such an image processing apparatus available, in which, when a user selects the sheet feeding unit at the print time, the user determines whether or not the sheet feeding unit can deal with the job, and compares the conditions thereof when executing the job, and selects the sheet feeding unit by automatically changing the sheet feed (for example, Japanese Patent Publication No. 3365988).

Further, a technique has been also known, in which, when the print job takes place, in case a manual sheet feeding unit is inconsistent with the print job, the print from the manual sheet feed is prevented (for example, Japanese Patent Application Laid-Open No. 2000-137415).

As described above, a technique has been conventionally known, which determines the print attribute value (print condition) carried by the print job and adjustability of the sheet feeding unit for the attribute value, and controls the selection of the sheet feeding unit and prohibition/permission of the print.

However, in the apparatus where the cost cutting is a matter of the highest importance, it is difficult to attach various types of sensors to the sheet feeding unit due to cost reduction, and hence, there are some apparatuses in which the sheet feeding unit is unable to recognize the details of the sheet which is fed, and in this type of the apparatus, it is necessary for the user to adequately set up attributes such as the size and type of the sheet, a print quality (print speed), and the like.

Particularly, in case a complex apparatus (multifunction peripheral) using an ink jet has a plurality of sheet feeding units, since an ink jet engine can print for various types of papers, a wide variety of paper types are assumed to be feed objects, and there are some apparatuses in which the user can set up attribute values such as a wide range of paper sizes and types, print quality and the like for every sheet feeding unit. In this manner, complex information on the sheet feed can be processed on conditions that various types of papers can be loaded on the sheet feeding unit and the user can perform a correct setup.

In the meantime, when a specific print mode referred to as a so-called application copy mode, for example, such as a print (seal print) onto a seal (label and sticker) paper, a copy onto a post card, a 2 in 1 copy, and the like are set up, a sheet size, a sheet type, a print quality and the like are sometimes controlled for the print.

For example, as shown in FIG. 9, in case an application copy mode of the print is set up and the sheet feeding unit is changed over, since a sheet size, a sheet type, a print quality, and the like are set up for every sheet feeding unit, the setup limit by the application copy mode and the setup value of the designated sheet feeding unit after the changeover are sometimes inconsistent.

FIG. 9 shows states of Indication on LCD (left column), User Operation (center column), and Feeder as Selected (feeder, right column) of the image processing apparatus, and shows an example (A to E) of how the states of Indication on LCD and Feeder as Selected change over according to the user operation in case the seal print is performed.

In the initial state of this operation of FIG. 9, a rear feeder is selected as a sheet feeding unit.

In A of FIG. 9, the user adequately performs the setup of a seal mode, and after that, he is requested to operate a start button (not shown). At this time, the user operates a feeder select key, recognizing that the seal is loaded in the front cassette, and selects the front cassette in replacement of the feeder as currently selected. However, at this time, as shown in B, an indication to the effect that the setup for a recording sheet is wrong and urging a correct setup to be made is displayed. This is because an attribute state of the front cassette is a plain A4 paper similarly to the right column of B, and causes inconsistency.

In compliance with this indication, the user performs a correct setup for the recording sheet of the front cassette by a menu operation and the like (not yet in a selected state) similarly to C. Here, the sheet size and the sheet type of the front cassette, and the attribute such as the print quality and the like are correctly set.

In this manner, though the setup result of the front cassette becomes similar to the right column of C (showing a state of the feeder selected as an object of the setup operation of C), the current selected state still remains as the rear feeder, and as shown in D to E, by operating the feeder select key further, the front cassette having finished the attribute setup must be selected.

The complicated operations as shown in FIG. 9 are required also when, for example, a seal copy mode indicating that the sheet size is settled on a seal size is set up in the job, the changeover is made to the sheet feeding unit which has been set up with a A4 size.

As described above, in the constitution in which the user sets up the attribute of the sheet feeding unit, it has not been possible hitherto to simply perform the sheet feed changeover when the attribute of the job and the attribute of the sheet feeding unit are inconsistent. Hence, on occasion when the user changes the sheet feed, each setup value of the sheet feeding unit is changed over to the correct value, and after that, the user performs the sheet feed changeover. Otherwise, there has been a problem in that the print is not started, and its handling becomes extremely troublesome.

For example, to explain based on the example of FIG. 9, the sheet feeding unit (front cassette) in an attribute state inconsistent with a special print mode (application copy mode) is not instantly selectable, and it is only when the attribute of the sheet feeding unit is correctly set up and the changeover operations (D to E) to the sheet feeding unit are freshly performed that the selection can be made.

That is, hitherto, in case the sheet feeding unit is changed over when the application copy mode of the print is set up, since the sheet size, the sheet type, and the print quality are set up for each sheet feeding unit, it is not possible to simply perform the sheet feed changeover when the setup limit by the application copy mode and the setup value of the designated sheet feeding unit are inconsistent. Hence, there has been a problem in that, when the changeover is desired, each attribute of the sheet feeding unit is changed, and then, the user is required to perform the changeover of the sheet feeding unit, so that the operability becomes extremely low.

### SUMMARY OF THE INVENTION

An object of the present invention is to solve the above described problems, and to perform the changeover of the sheet feeding unit by easy operations without giving unnecessary burdens to the user even in case the application copy mode is inconsistent with the attribute setup state of the sheet feeding unit in the image processing apparatus having a plurality of sheet feeding units.

An image processing apparatus according to present invention has a plurality of sheet feeding units capable of setting up each attribute regarding each sheet to be stored, and a recording unit for performing a print output by using the sheet of the sheeting feeding unit selected by user among said sheet feeding units, wherein in a state in which a special print mode is selected, when a user performs an operation for changeover to the sheet feeding unit set with the attribute inconsistent with said special print mode, an attribute setup user interface of the sheet feeding unit selected by said changeover operation is activated, and after the attribute of the sheet feeding unit is set up, the changeover to the sheet feeding unit selected by said changeover operation is executed.

With the above described constitution, beneficial effects can be guaranteed in that, even in case the print mode inconsistent with the attribute setup state of the sheet feeding unit is used, priority is given to the sheet feeding unit changeover operation desired by the user, and after the attribute setup of the sheet feeding unit is properly performed in the attribute setup user interface of the sheet feeding unit, the changeover to the sheet feeding unit desired by the user can be realized, and without giving excessive burdens to the user, the changeover of the sheet feeding unit can be performed by an easy operation.

### BRIEF DESCRIPTION OF THE DRAWINGS

FIG. 1 is a block diagram showing the hardware constitution of the image processing apparatus adopting the present invention;

FIG. 2 is a block diagram showing an operation unit constitution in the apparatus of FIG. 1;

FIG. 3A is an explanatory drawing showing an example of the setup system (normal mode) of a copy size, a sheet type, and a print quality in the apparatus of FIG. 1;

FIG. 3B is an explanatory drawing showing an example of the setup system (application copy mode) of a copy size, a sheet type, and a print quality in the apparatus of FIG. 1;

FIG. 4 is an explanatory drawing showing an example of the sheet feed selective operation in the apparatus of FIG. 1;

FIG. 5 is a flowchart showing a sheet feed changeover control example in the apparatus of FIG. 1;

FIG. 6 is a flowchart showing a control example in a sheet setup screen accompanied with the sheet feed changeover in the apparatus of FIG. 1;

FIG. 7 is a flowchart showing a setup control example of the application copy mode in the apparatus of FIG. 1;

FIG. 8 is a flowchart showing a different control example in the sheet setup screen accompanied with the sheet feed changeover in the apparatus of FIG. 1;

FIG. 9 is an explanatory drawing showing the problem on occasion when the selective operation of a conventional sheet feeding unit is performed;

FIG. 10 is an explanatory drawing showing the selective operation of the sheet feeding unit by the present invention; and

FIG. 11 is an explanatory drawing showing a display example in case of adopting the control example of FIG. 8.

### DESCRIPTION OF THE PREFERRED EMBODIMENTS

Below are shown embodiments of an image processing apparatus performing an image recording and having a plurality of sheet feeding units.

### First Embodiment

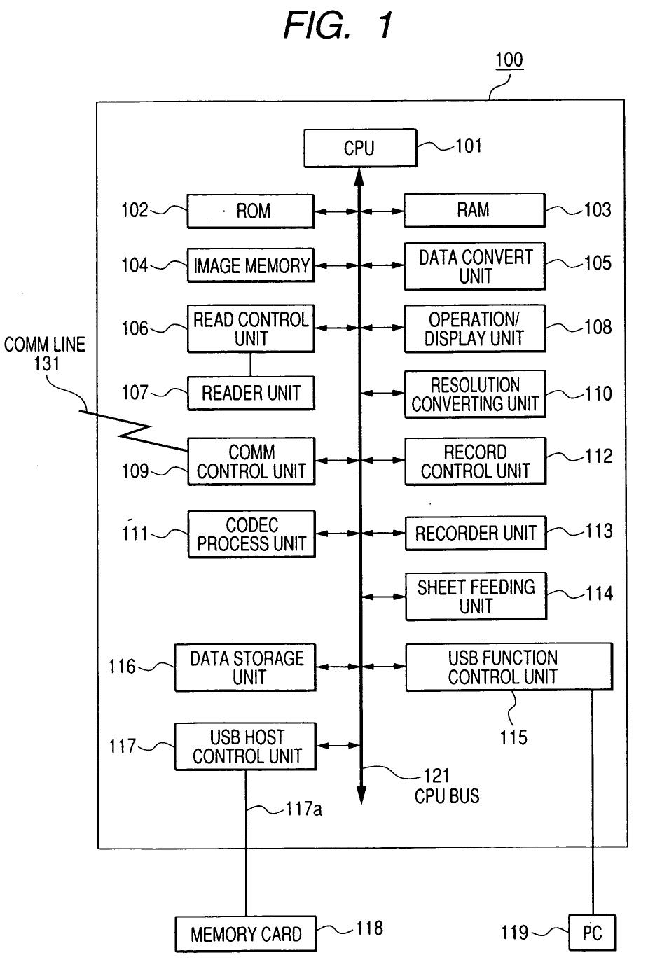

FIG. 1 shows a schematic structure of an image processing apparatus 100 adopting the present invention. In an image processing apparatus 100 of FIG. 1, a CPU 101 is a system control unit, and controls the whole of the image processing apparatus 100.

A ROM 102 stores a control program executed by the CPU 101, a built-in operating system (OS) program, and the like. In the present embodiment, each control program stored in the ROM 102 performs a software control such as a scheduling, a task switch, and the like under the control of the built-in OS stored in the ROM 102.

A RAM 103 is constituted by a SRAM (Static RAM) and the like, and stores a program control variable and the like, and moreover, stores a setup value registered by an operator and a management data of the image processing apparatus 100, and the like, and is formed with a buffer area for various types of works.

An image memory 104 is constituted by a DRAM (dynamic RAM) and the like, and accumulates image data.

A data convert unit 105 performs convert of the image data such as analysis of page description language (PDL) and the like and development and the like of CG (Computer Graphics) of character data. The data convert unit 105 may be constituted not only by exclusive hardware, but also by software of the CPU 101.

The image processing apparatus 100 of the present embodiment is constituted such that both of image reading and image recording can be performed. Among them, regarding the image reading, a read control unit 106 and a reader unit 107 controlled by the read control unit 106 are provided.

The read control unit 106 treats an image signal, in which an original is optically read by a image sensor (contact image sensor) by the reader unit 107 and converted into an electrical image data, with various image processings such as a binarization processing, a halftone processing, and the like through an image processing apparatus control unit (not shown), and outputs highly precise image data. Incidentally, in the present embodiment, the read control unit 106 has a conveying mechanism in which both a sheet read control system to read the original while conveying it and a book read control system to scan the original on a copy board are possible.

An operation unit 108 is a display unit comprising a numeric value input key, a letter input key, a one touch telephone number key, a mode setup key, a decision key, a cancellation key, and the like, and is constituted by various function keys for deciding image data transmit destination data and performing registration operations of setup data of registered value and setup of energy saving mode by a user, and LED (light emitting diode), LCD (liquid crystal display), and the like, and performs a display and the like of various input operations by an operator, an operating state of the image processing apparatus 100, a status condition, and the like.

The image processing apparatus 100 of the present embodiment is constituted in such a manner as to be able to transmit and receive image data through a communication line 131. Hence, the image processing apparatus 100 of the present embodiment is provided with a communication control unit 109, a resolution converting unit 110, a CODEC process unit 111, and the like.

The communication control unit 109 is constituted by a MODEM (modulation demodulation unit), a NCU (network control unit), and the like. In the present embodiment, the communication control unit 109 is connected to an analogue communications line (PSTN) 131, and performs a communication control by a T30 protocol, and a line control such as call-out and call-in and the like for the communications line. Incidentally, the constitution of the communications line is arbitrary, and for example, in case a communication system such as a VoIP and the like is used, the communication control 109 adopts a constitution conforming to a communication system such as an ADSL modem, a splitter, and the like.

The resolution converting unit 110 performs a resolution convert control such as a millimeter inch resolution convert of the image data, and the like. Further, the resolution convert unit 110 can perform a magnification/reduction process of the image data.

The CODEC process unit 111 performs a CODEC processing of the image data (MH, MR, MMR, JBIG, JPEG, and the like) handled by the image processing apparatus 100 and the magnification/reduction processing.

The image processing apparatus 100 of the present embodiment has a record control unit 112, a recorder unit 113, and a sheet feeding unit 114 for image recording and outputting.

Among them, the record control unit 112 gives various image processings such as a smoothing processing and a recording density correction processing, a color correction, and the like to the image data to be printed through the image process control unit (not shown), and converts it into highly precise image data, and outputs it to the recorder unit 113 to be described later. Further, the record control unit 112 has a function to periodically acquire state information on the recorder unit 113 by controlling the recorder unit 113.

The recorder unit 113 is a printer constituted by hardware by any recording system such as a laser beam printer, an ink jet printer, and the like, and prints a color image data or a monochrome image data on a print member.

The sheet feeding unit 114 holds sheets for print, and feeds the sheets for the recorder unit 113 by control of the record control unit 112.

The sheet feeding unit 114 is prepared in plurality to hold a plurality of different types of sheets, and is controlled by the control of the record control unit 112 as to from which sheet feeding unit the sheet feed is performed.

In the present embodiment, as an interface of the image processing apparatus 100 and a PC 119, a USB function control unit 115 is provided.

The USB function control unit 115 performs a protocol control in conformity to the USB communication standard, and converts the data from a USB control task executed by the CPU 101 into a packet, and performs a USB packet transmission to the PC 119 or inversely converts the USB packet from the PC 119 into data and transmits it to the CPU 101.

A data storage unit 116 is a storage unit for storing data. Since the DRAM constituting an image memory 104 is not provided with an area for data backup, in the present embodiment, in the present embodiment, as the data storage means, the data storage unit 116 is provided. However, in case the image memory 104 is provided with means for backup or the like, this data storage unit 116 may be not particularly provided. This data storage unit 116 can perform the backup of the record data and the control data. In the present embodiment, though the DRAM can be used as the data storage unit 116, a hard disk, a volatile memory, and the like can be also used, and the system of the storage medium constituting the data storage unit 116 is arbitrary.

A USB host control unit 117 is a control unit for performing a communication by a protocol regulated by the USB communication standard. The USB communication standard is a regulation which can perform a bi-directional data communication at high speed, and can connect a plurality of hubs or functions (slaves) for one set of host (master). In the present embodiment, the USB host control unit 117 can be connected to a memory card 118 through a USB interface 117a.

Alternately, the USB host control unit 117 can be also connected directly to a digital camera.

The memory card 118 is a data storage medium, and is connected to the image processing apparatus 100 through the USB interface 117a. The CPU 101 can access to the image data and other electronic data stored in the memory card 118 through the USB host control unit 117. Incidentally, in the present embodiment, the USB communication of a record function uses a one for one connection mode.

Each of the constituent elements under reference numbers 101 to 106 and 108 to 114 is mutually connected through a CPU bus 121 controlled by the CPU 101.

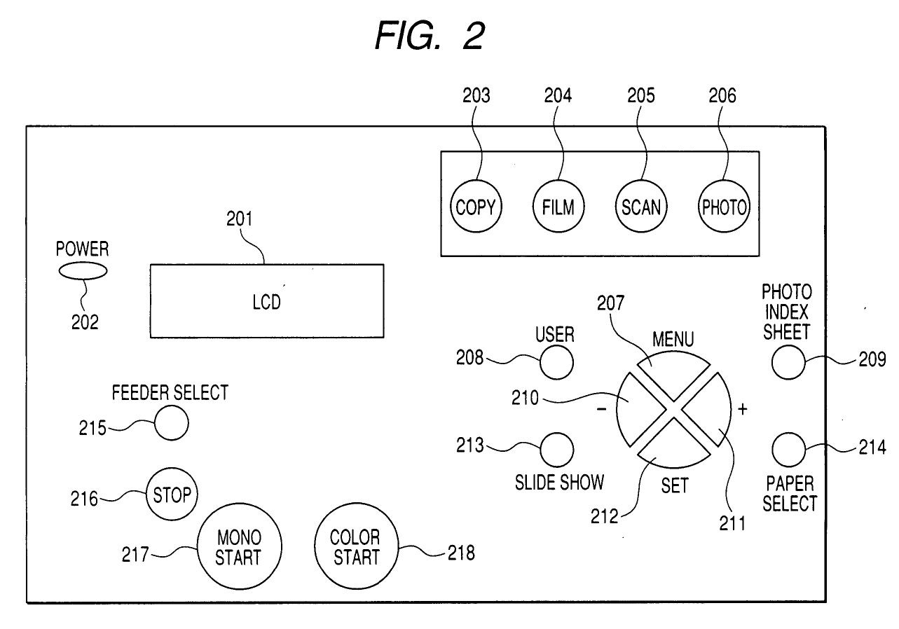

FIG. 2 shows a structural example of the operation unit 108 of the image processing apparatus 100 of FIG. 1.

As shown in FIG. 2, the operation unit 108 of the present embodiment is provided with a LCD 201 used for displaying a message, an operation prompt, and various information, and in addition, various keys such as a power supply key 202, a copy mode key 203, a film mode key 204, a scan mode key 205, a photo mode key 206, a menu key 207, a user setup key 208, a photo index sheet key 209, a minus key 210, a plus key 211, a set key 212, a slide show key 213, a sheet setup key 214, a feeder select key 215, a STOP key 216, a monochrome start key 217, and a color start key 218. The function of each key will be described below.

The power supply key 202 is a key for turning ON/OFF the power supply of the apparatus.

The copy mode key 203 is a key for putting the image processing apparatus 100 into a state in which a copy can be made. Through the depression of this copy mode key 203, the apparatus can be put into a copy mode.

The film mode key 204 is a key for putting the image processing apparatus 100 into a state in which the print can be made from a film. Through the depression of this film mode key 204, the apparatus can be put into a film mode.

The scan mode key 205 is a key for putting the image processing apparatus 100 into a state in which a scan can be made. Through the depression of this scan mode key 205, the apparatus can be put into a scan mode.

The photo mode key 206 is a key for putting the image processing apparatus 100 into a state in which a direct print can be made from the card of a digital photography and a camera. Through the depression of this photo mode key 206, the apparatus can be put into a photo mode.

The menu key 207 is a key for displaying an item for setting up a setup value at the executing time of a direct print and the like from a copy, a facsimile, a card and the like. Through the depression of this photo menu key 207, a menu item for execution can be displayed in the LCD 201. Moreover, the menu item can be selected by the plus key 211, the minus key 210, and the like, and can be set by the set key 212.

The user setup key 208 is a key for displaying a screen for registering a setup value for setting up in the apparatus by the user. Through the depression of the user setup key 208, the user setup item can be displayed in the LCD 201, and moreover, can be selected by the plus key 211, the minus key 210 and the like, and can be set by the set key 212.

The photo index sheet key 209 is a key capable of shifting to a screen for print or reading a photo index sheet. When this key is depressed in a state in which a memory card 118 is inserted into the image processing apparatus 100, the process moves to a setup screen capable of instructing print or reading of the photo index sheet, and reading or print is selected by the plus key 211 or the minus key 210, and the function set by the set key 212 can be executed.

The minus key 210 and the plus key 211 are keys used when the user performs selection such as a menu, a user registration and the like from a plurality of alternatives. Although the meaning of the minus or the plus can be used for various meanings according to a context, in general, it is used for designating an operational direction in a reverse order or a normal order, respectively.

The set key 212 is a key for performing a decision for the selected item.

The slide show key 213 is a specification for displaying the images of the memory card 118 in order in the display unit 108.

The sheet setup key 214 is used for performing the sheet setup for a copy or other print setup.

The feeder select key 215 is used when a changeover to a target sheet feeding unit is performed in case the sheet feeding unit of the sheet feeding unit 114 is constituted by a plurality of sheet feeding units.

The STOP key 216 is a key for stopping a facsimile transmission and reception, and copy and other operating operations.

The monochrome start key 217 is a key for starting a monochrome facsimile transmission, and a monochrome copy.

The color start key 218 is used for starting a color facsimile transmission, a color copy and a color photographic print.

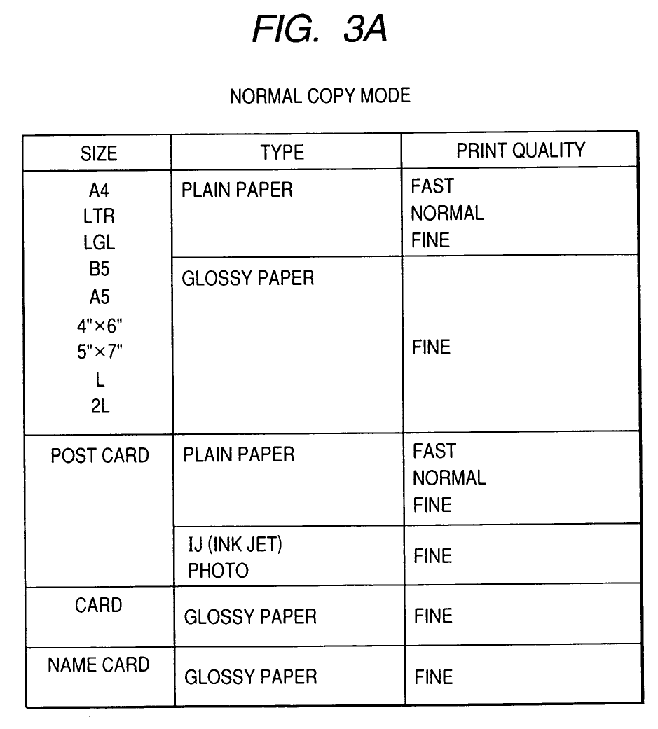

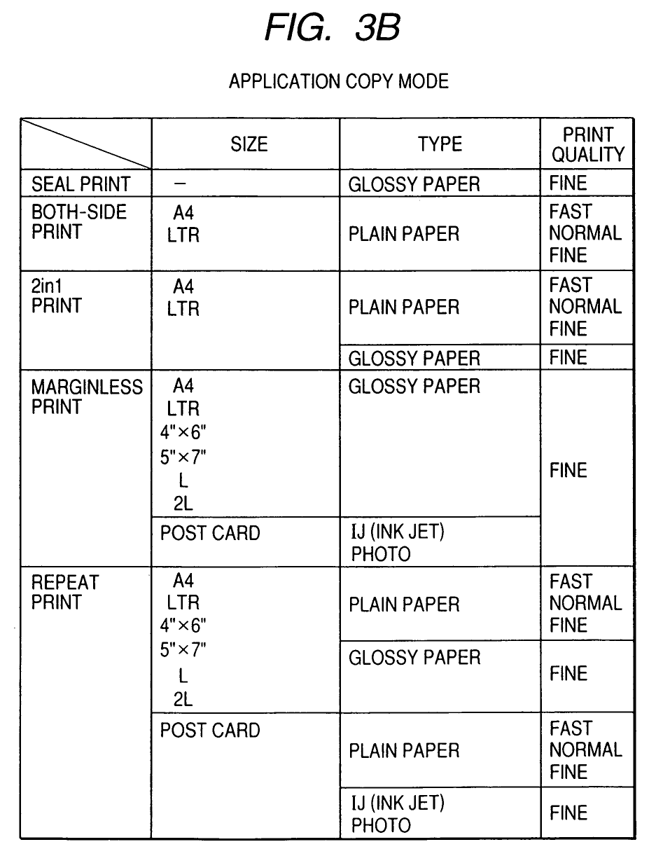

FIGS. 3A and 3B shows an example of a setup operation system such as a copy size, a sheet type, a print quality and the like of in the image processing apparatus 100 of the present embodiment. In the present embodiment, these attributes are set in the setup for the print job or the sheet feeding unit. For the sheet feeding unit, the user is supposed to perform the attribute setup.

FIG. 3A shows an example of a normal copy setup value, and based on size information in the left column, a selection is controlled by the attributes of the sheet type (plain paper, glossy paper, IJ photo, and the like) and the print quality ((fast), (normal), and (fine)) shown in the center and the right columns. Incidentally, in the present embodiment, though the attribute expression such as (fast), (normal), and (fine) is used as the print quality, these qualities may be shown by using another attribute expression such as high speed (low quality), medium speed (medium quality), and low speed (high quality).

For example, as shown in FIG. 3A, for a post size, the sheet type can designate only two types of an ink jet (IJ) and a photo in addition to the plain paper, and further, in case the sheet type is a glossy paper, the print quality becomes only (fine).

In this manner, in the present embodiment, though a limit is imposed on a setup which can select the size, the sheet type, and the print quality to be set by the attribute value, this is naturally meant to acquire the best output result according to the specification of the recording hardware and the like.

Further, FIG. 3B shows an example of the setup system by a copy application mode. This copy application mode is a special print mode such as a seal print, a both-side print, a 2 in 1, a marginless print, a repeat print and the like, and as shown in the figure, a limit is imposed on the size settable for each mode. For example, when the mode is set to a “seal” print, the size is set to a seal (sticker). Then, the sheet type is set to a glossy paper, and the print quality is set to (fine). Alternately, in the case of the “both-side” print or the “marginless” print, the size is limited to either A4 or LTR. In addition, the both-side print is limited to the plain paper. Further, in the application copy mode also, a “repeat” print can be set identically with a normal copy. In this manner, when the application copy mode is set, the attributes of the copy mode are put into a state in which they must be limited and set.

Incidentally, the setup systems shown in FIGS. 3A and 3B are strictly just an example, and the constitution of its details is optional at those skilled in the art. Needless to mention, for example, if it is a value to decide the attribute of the print, the attribute other than those shown here may be settable.

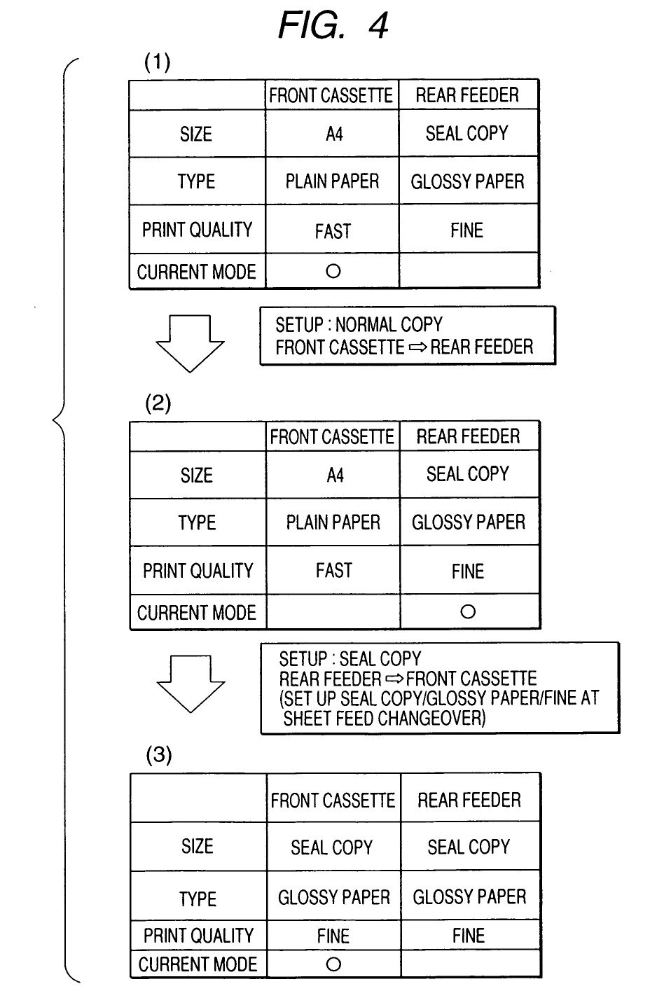

FIG. 4 shows an example of a selective operation of the sheet feeding unit in the image processing apparatus 100 of the present embodiment. FIG. 4, as shown by each of Tables 1 to 3, shows a state in which a setup is made in each of two sheet feeding units in case there are two sheet feeding units in the form of a front cassette and a rear feeder.

In the present embodiment, the sheet size, the sheet type and the print quality are set for each of the front cassette and the rear feeder. In the state of Table 1, the front cassette is set with (A4/plain paper/fast), and the rear feeder is set with (seal/glossy paper/(fine)). Subsequently, Table 2 and Table 3 show the change of the setup state in case the sheet feed changeover (to be described later) is performed from the state of Table 1 at the normal copy mode setup time. The blocks between each Table show the operation of the user.

In the shift from Table 1 to Table 2 of FIG. 4, the user performs the normal copy operation, and here, he performs the changeover from the front cassette to the rear feeder. On the occasion of the normal copy setup, only the current setup is changed, and each setup of the sheet feeding units is not changed. As a result, a state of the Table 2 comes out.

This state of Table 2, as shown in FIG. 3B, selects a seal copy mode in which the sheet and the quality are limited (for example, paper other than seal is not usable) and the state of the cassette in Table 1 and Table 2 is in a state inconsistent with the seal copy mode.

From this state of Table 2, the user further changes over to the seal copy mode, and yet the user desires to changeover the sheet feeding unit from the rear feeder to the front cassette.

In such a state, according to the prior art, unless the state of the front cassette is properly changed in the setup, it has been impossible to changeover to the front cassette. However, in the present embodiment, a user interface is activated in such a manner that not only the changeover to the front cassette is allowed, but also the user is allowed to change the attribute setup of the front cassette to be adjusted to the seal mode.

By this user interface, if the user sets up a correct attribute of (seal) (glossy paper) and (fine) possible in the seal copy mode for the front cassette (needless to mention, the state of the actual front cassette is properly put into a maintenance status), as shown in Table 3 of FIG. 4, the sheet feed can be changed over from the rear feeder to the front cassette.

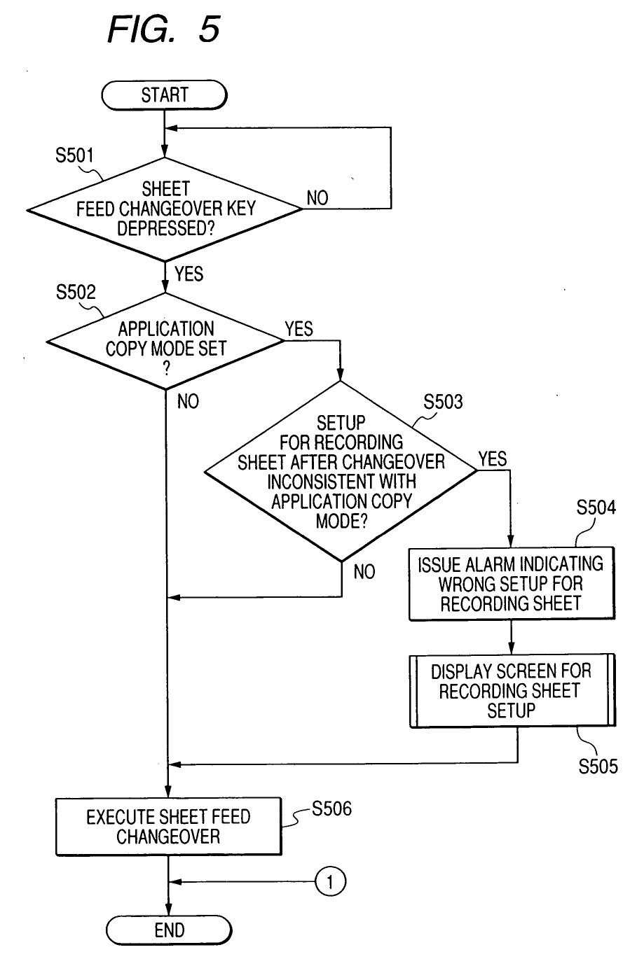

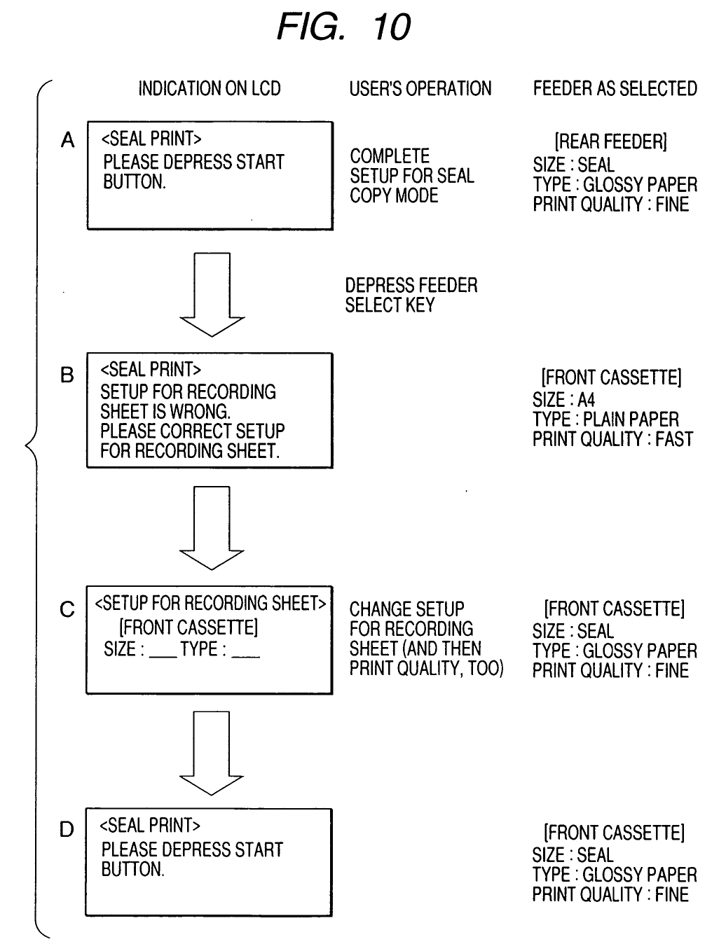

FIG. 5 shows an example of the changeover control of the sheet feeding unit at the time of the sheet feed changeover. FIG. 5 shows a setup control on occasion when the sheet feed changeover is performed in the image processing apparatus 100. The illustrated procedure is stored in the ROM 102 and the like as a program of the CPU 101 (the same applies to the flowchart to be described later). Further, the shift from the setup state of the display of the LCD through the user operation to the setup state of the feeder corresponding to the control of FIG. 5 is shown in FIG. 10.

First, at step S501 of FIG. 5, the CPU 101 determines whether or not a sheet feed changeover key is depressed. In case the sheet feed changeover key is depressed, next, the procedure advances to step S502. In case the sheet feed changeover key is not depressed, at step S501, the procedure waits till the sheet feed changeover is performed.

At step S502, it is determined whether or not the application copy mode is set up. Particularly if the application copy mode is not set up, the procedure advances to step S506 and performs the sheet feed changeover. In the meantime, at step S502, if the application copy mode is set up, the procedure moves to step S503.

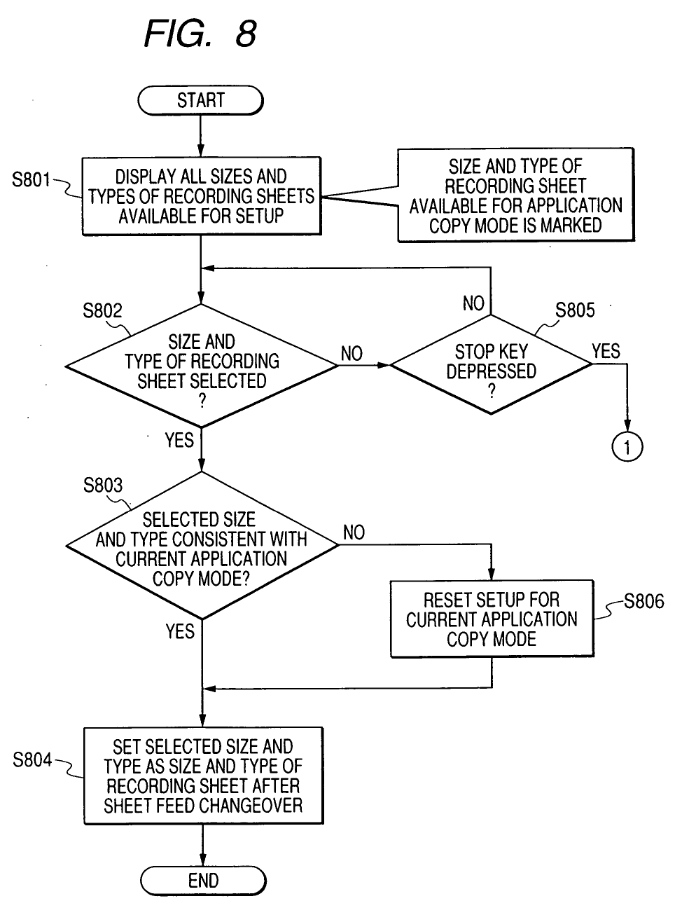

Incidentally, though the application copy mode is set up by the control as shown in FIG. 8 to be described later, as evident from a description on FIG. 10, a seal mode which is one of the application copy modes is selected in FIG. 10A.

Subsequently, at step S503, the user determines whether or not the attributes such as the size, the type and the like of the sheet set up in the sheet feeding unit designated by the operation of step S501 are consistent with the limit by the application copy mode of the print currently set up. If the setup value within the limit of the application copy mode is set up as the attribute of the sheet feeding unit, the procedure moves to step S506, and the sheet feeding unit is actually changed. In the meantime, at step S503, in case the attributes such as the size, the type, and the like of the sheet set up in the sheet feeding unit have become the setup value other than the limit of the application copy mode, the procedure moves to step S504.

At step S504, an alarm indicating that a wrong setup has been made is issued to the display unit 108 of the apparatus by using the display unit 108 of the apparatus, and the procedure moves to step S505. This alarm display corresponds to B of FIG. 10. However, this display is strictly just an alarm, and does not prohibit the changeover to the sheet feeding unit which is inconsistent in attributes as heretofore. In the present embodiment, at step S505, the changeover to the sheet feeding unit desired by the user is permitted, and moreover, a sheet setup user interface regarding the sheet feeding unit is displayed, so that the attribute setup is performed. In this stage, the user can perform the attribute setup of the sheet regarding the sheet feeding unit being a changeover destination.

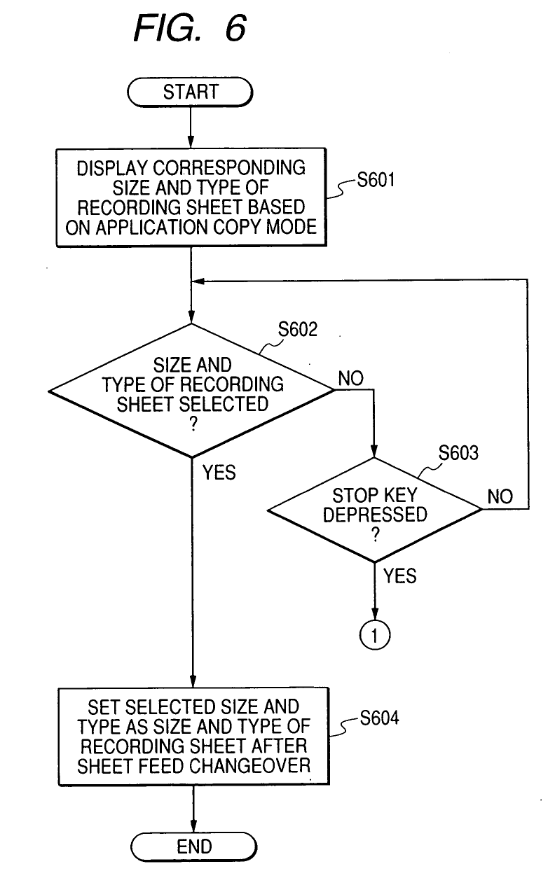

While the details of the setup control of step S505 will be shown in FIG. 6 to be described later, in FIG. 10, the display of the sheet setup user interface regarding the sheet feeding unit designated for the changeover corresponds to the display screen of C.

At step S505, when the setup of the sheet is completed, at step S506, the changeover of the sheet feeding unit is performed. In the example of FIG. 10, the attributes of (A4) (sheet size), (plain paper) (sheet type), (fast) (print quality) of the front cassette are changed to (seal), (glossy paper), and (fine), respectively.

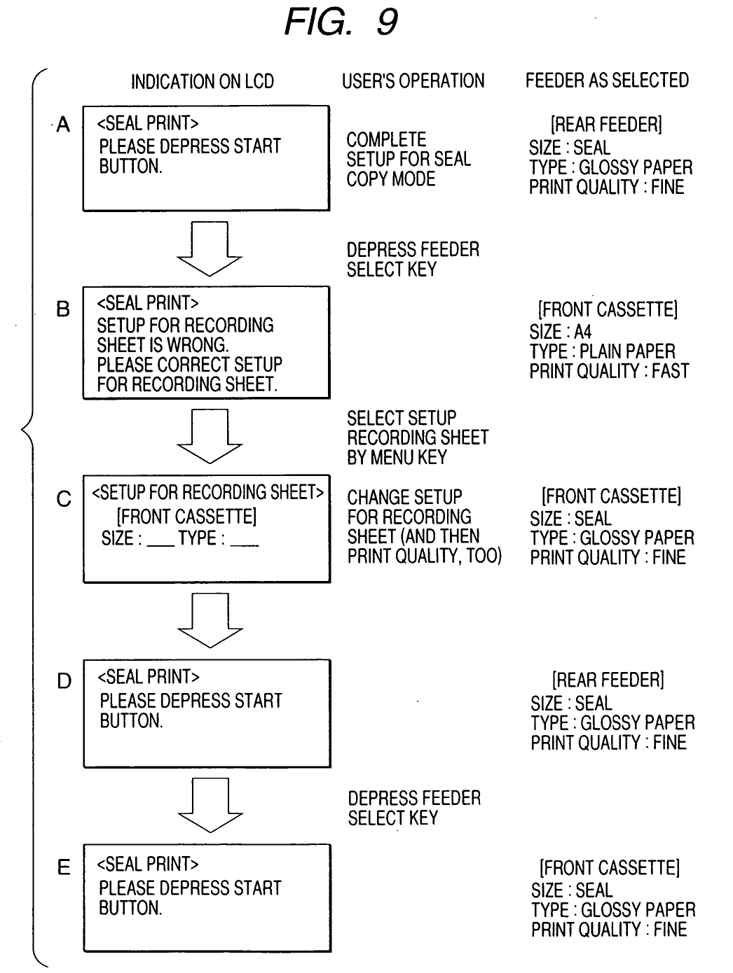

At step S506, a changeover of the sheet feeding unit having thus finished the attribute setup is performed. As shown in D of FIG. 10, according to the present embodiment, the wasteful selection of the sheet feeding unit as shown in D to E of FIG. 9 is not repeated, and the sheet feeding unit designated by the user as shown in D of FIG. 10 is selected in a state in which the attributes are properly set up.

FIG. 6 shows a setup control example on occasion when the sheet feeding unit is changed in the application copy mode performed at step S505 of FIG. 5. By this control of FIG. 6, a sheet setup user interface of the sheet feeding unit (front cassette) in C of FIG. 10 is executed.

First, at step S601, a sheet size usable in the application copy mode is displayed. Here, for example, as shown in Table 2 of FIG. 4, assume that the rear feeder is selected as the sheet feeding unit, and the seal copy is selected as the application copy mode. In this case, the sheet feed selective operation is performed, and in case the sheet setup screen is entered, as the sheet size usable, the seal copy becomes an alternative, and as the sheet type, the glossy paper becomes an alternative, and hence, the seal copy and the glossy paper are displayed as selected items.

Further, for example, in case the application copy mode which has been set up is a 2 in 1 copy, as evident from FIG. 3B, as the sheet size, the A4/LTR are selectable, and as the sheet type, a plain paper or a glossy paper is selectable. Hence, as the sheet size, the selection of the A4/LTR, and as the sheet type, the selection of the plain paper or the glossy paper are displayed as selected items.

As described above, at step S601, the size/type of the sheet selectable are displayed, and after that, at step S602, it is determined whether or not the size and type of the sheet are set up. In case the selection of the size and type of the sheet is performed, the procedure moves to step S604, and in case the selection is not performed, at step S603, it is determined whether or not the STOP key 216 is depressed. If the key is depressed, the procedure advances to a bifurcation (exit operation of FIG. 5) of the numeral 1 enclosed in a circle, and stops the processing, and in this case, the processing is finished without the sheet feed changed. That is, here it means that, through the depressing of the STOP key 216, the sheet feed changeover is finished without being completed. In the meantime, at step S603, if the STOP key is not depressed, at step S602, the procedures waits again for the selection of the size and type of the sheet.

When the size/type of the sheet are set up, at step S604, the size and type of the sheet set up at step S602 are set up as the setup value of the sheet size and the sheet type after the changeover.

In the manner as described above, the sheet setup is displayed to the user at the changeover time of the sheet feed, and the sheet setup can be simply set up at the changeover time. That is, in case the user sets up the application copy mode of the print and changes the sheet feed, even when the sheet feed changeover is performed, the setup of the sheet feeding unit after the changeover can be performed without performing the sheet setup operation in advance, so that the operability can be sharply improved.

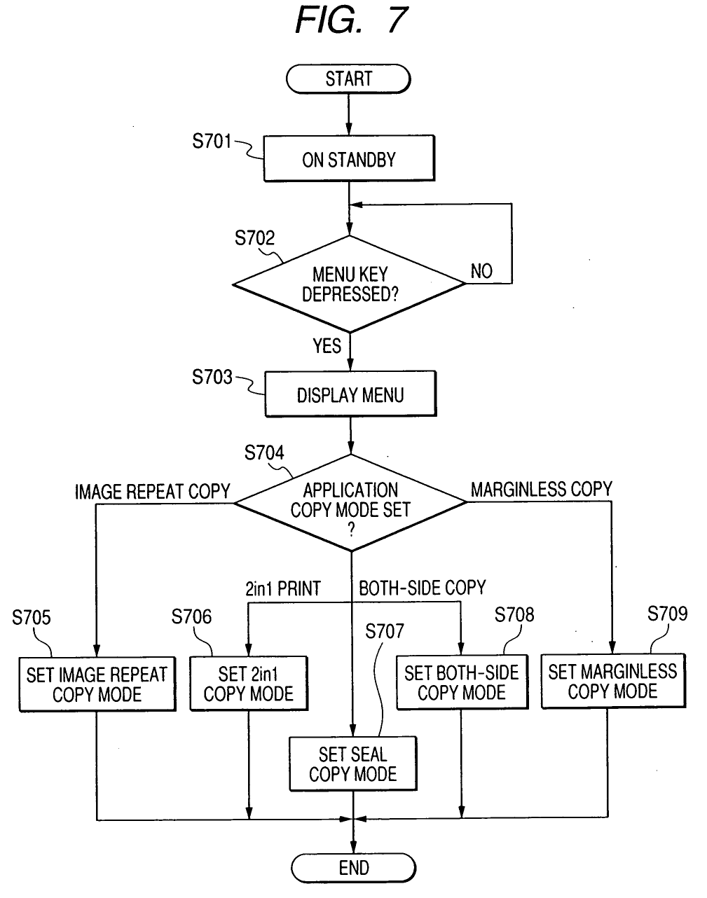

FIG. 7 shows a setup control example of the application copy mode.

Step S701 of FIG. 7 shows a waiting state of the apparatus, and at step S702, the operation of the menu key 207 is awaited, and when the menu key 207 is operated, the procedure advances to step S703.

When the menu key 207 is operated, at step S703, the menu is displayed to the LCD 201. By this menu, the setup change of the copy, a detailed setup of the apparatus, the application copy mode, and the like can be set up.

At step S704, it is determined whether or not various application copy modes are set up. Here, when an image repeat copy is set up, at step S705, the image repeat copy mode is set up. Further, at step S704, in case a 2 in 1 copy is set up, at step S706, the 2 in 1 copy mode is set up. Further, at step S704, in case a seal copy is set up, at step S707, the seal copy mode is set up. Further, at step S704, in case a both-side copy is set up, at step S708, the both-side copy mode is set up. Further, at step S704, in case a marginless copy is set up, at the step S709, the marginless copy mode is set up. In this manner, various types of the application print modes of the image processing apparatus 100 can be set up.

As described above, the changeover of the sheet feeding unit on occasion when the application print mode (special print mode) is set up can be executed as a value change of the print attribute value of the sheet feeding unit after the changeover performed at a timing of the sheet feed changeover without requiring complicated operations such as freshly executing the setup after performing as before the setup of the sheet feeding unit subsequent to the changeover performed in advance by the user.

Consequently, without performing as before the complicated operations such as C, D, and E of FIG. 9, as shown in FIG. 10, the user can perform the sheet feed changeover and the attribute setup of the sheet feeding unit being a required changeover destination without suffering stresses. As evident from the comparison with FIG. 9, in FIG. 10, the user operation directly shifts from C to D, and it is clear that the step at D which is unnecessarily performed in FIG. 9 is not required.

Further, with priority given to the fact that the application copy mode is set up by the user, the sheet feed selection, which takes into consideration that the application setup of the copy is not released as much as possible, can be performed.

### Second Embodiment

The sheet change control at the sheet feeding unit changeover time shown in FIG. 6 of the first embodiment may be replaced by the control such as shown in FIG. 8. In the present embodiment, except for FIG. 8, hardware constitution and software constitution may be the same as the first embodiment, and the description thereof will be omitted.

FIG. 8 shows a sheet control example at the sheet feed changeover time in the application mode setup state performed at step S505 of FIG. 5.

At step S801 of FIG. 8, the settable sheet size and type are displayed. Being different from the first embodiment, which displays the setup only usable in the application mode as an alternative, the present embodiment displays all the sheet types and sheet sizes settable by the apparatus.

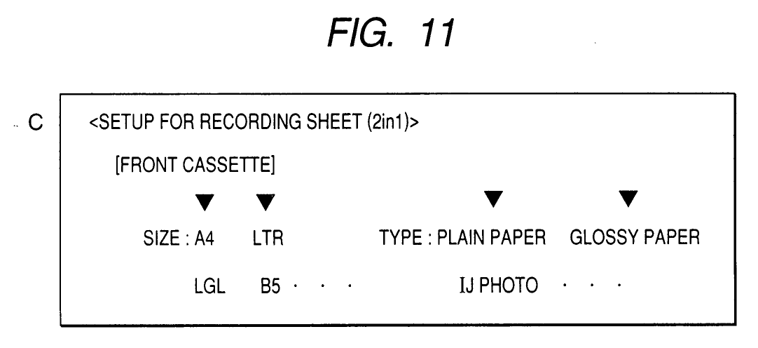

For example, assuming that a 2 in 1 mode is set up as the application copy mode, when a sheet feed changeover is performed, and the setup attribute of the sheet feeding unit after the changeover is not 4A/LTR (see FIG. 3B) usable in the 2 in 1 mode, though, in the case of the first embodiment (step s601 of FIG. 6), A4 or LTR alone is displayed, in the case of the present embodiment, as shown in FIG. 11, the setup of the sheet settable by the apparatusesuch as A4, LTR, LGL, B5 . . . are all displayed as the alternatives.

However, at this step S801, the sheet attribute used in the application copy mode at the display time is displayed by a mark, which can be used in the application copy mode. That is, in FIG. 11, a black triangular mark is displayed in the LCD 201, and 4A or LTR usable in the 2 in 1 copy mode are displayed so as to be differentiable. Further, the attribute not attached to this black triangle mark is not made non-selectable (see the following step S803), but the user can enforce the selection.

Incidentally, in the present embodiment, though the (black triangle) mark is used for the attribute usable in the application copy mode, if such a display is a display to the effect that it is an attribute value limited in the application copy mode, it may be performed by an arbitrary form.

Subsequently, at step S802, it is determined whether or not the sheet type is set up. Here, if the sheet type is not set up, it is determined whether or not the STOP key 216 is depressed at step S805. If the STOP key 216 is depressed, similarly to the case of FIG. 6, the sheet feed changeover is not performed, but is finished. At step S805, if the STOP key 216 is not depressed, at step S802, the procedure waits again till the setup of the sheet size and type is performed.

At step S802, when the setup of the sheet size and type is performed, at step S803, it is determined whether or not the sheet size and type set up at step S802 are inconsistent with the application copy mode currently set up. If inconsistency occurs, the procedure advances to the next step S806, and releases the setup of the application copy mode.

That is, in the present embodiment, a priority is given to the setup operation of the attributes such as the size and type of the sheet desired by the user, and if such an operation is inconsistent with the print mode (application mode), then, the print mode (application mode) is released.

In the meantime, at step S803, if the operation is not inconsistent with the application copy mode, next, the procedure moves to step S804, and the sheet feed information set up in the sheet feeding unit after the sheet feed changeover performed at step S802 is set up.

In this manner as described above, in case the attributes such as the sheet size, the sheet type and the like which are not inconsistent with the application copy mode at the sheet setup time are set up, the sheet feed changeover is performed so that the setup is made in the sheet feeding unit after the changeover, and further, in case inconsistency occurs, a priority is given to the up-to-data setup operation of the user, that is, the setup operation of the sheet size and type, and if such operation is inconsistent with the print mode (application mode), the print mode (application mode) is released.

If, by the above described method, the sheet desired to be used by the user after the sheet feed changeover does not correspond to the application copy mode at the sheet feed changeover time, the application copy mode is automatically released, and a priority is given to the setup of the sheet desired by the user. Further, if within the limit of the application copy mode at the sheet setup time, the setup can be made with the application copy mode left as it is.

That is, the priority of the sheet feed selection is raised higher than the first embodiment, and the sheet feed selection can be always performed without making inconsistent setup, and in case the release is required, the sheet feed changeover is performed, so that the application copy mode can be automatically released. Comparing with the first embodiment, the second embodiment is different in that the user gives a priority to the sheet feed selective operation recently performed, and if there is inconsistency with the print mode setup, the print mode setup method is changed, and the sheet feed selective operation recently performed and desired by user is respected and executed.

Incidentally, various types of the application print modes illustrated in each of the above described embodiments are nothing but an example, and if it is a special copy (print/recorder output) mode limiting the attribute value of the print such as sheet type and the sheet size, it goes without saying that the same control as described above can be performed, and moreover, as the attribute information on the copy (print/recorder output) mode regarding the sheet feeding unit selection, though the sheet size and the sheet type are shown, these attributes are not limited by the above described mode, and needless to mention, even other attributes can perform the same control with regard to the attributes affecting the operation of the application copy mode.

Further, in each of the above described embodiments, though two sets of the front cassette/rear feeder are displayed as the sheet feeding unit at the sheet feed changeover time, it goes without saying that, even if there are many more sheet feeding units available, the same control can be performed.

If the present invention is an image processing apparatus having a plurality of sheet feeding units in which attribute information is set up for each sheet feeding unit, it can be adapted to any image processing apparatus.

The software for realizing the method and program of the present invention is not limited to the ROM (RAM), and can be stored in other storage media such as a floppy disk (brand name), CDROM, a hard disk, a memory card, a magnetic optical disk, and the like. Further, the software can be introduced into these apparatuses through a network, and moreover, can be constituted so as to be updated.

This application claims priority from Japanese Patent Application No. 2004-228773 filed Aug. 5, 2004, which is hereby incorporated by reference herein.

What is claimed is:

1. A control method of an image processing apparatus having a plurality of sheet feeding units capable of setting up each attribute regarding each sheet to be stored, and a recording unit for performing a print output by using the sheet of the sheeting feeding unit selected by user among said sheet feeding units,
wherein, in a state in which a special print mode is selected, when a user performs an operation for changeover to the sheet feeding unit set with the attribute inconsistent with said special print mode, an attribute setup user interface of the sheet feeding unit selected by said changeover operation is activated, and after the attribute of the sheet feeding unit is set up, the changeover to the sheet feeding unit selected by said changeover operation is executed.

2. The control method of the image processing apparatus according to claim 1, wherein the attribute only usable in said special print mode is displayed in the attribute setup user interface of said sheet feeding unit.

3. The control method of the image processing apparatus according to claim 1, wherein the attribute usable in said special print mode is displayed so as to be differentiable from other attributes in the attribute setup user interface of said sheet feeding unit.

4. The control method of the image processing apparatus according to claim 3, wherein, in case the attribute inconsistent with said special print mode is set up, a priority is given to the attribute setup of the user, and after said special print mode is released, the changeover to the sheet feeding unit selected by said changeover operation is executed.

5. An image processing apparatus, wherein the control method of the image processing apparatus according to any one of claims 1 to 4 is executed.

6. A control program of the image processing apparatus, wherein the control method of the image processing apparatus according to any one of claims 1 to 4 is executed in a predetermined image processing apparatus hardware.

7. A control program of the image processing apparatus, wherein the control method of the image processing apparatus according to claim 5 is executed in a predetermined image processing apparatus hardware.
